(19) United States
(12) Patent Application Publication
(10) Pub. No.: US 2025/0250396 A1
(43) Pub. Date: Aug. 7, 2025

(54) POLYORGANOHYDROGENSILOXANE COMPOSITION INCLUDING A LEWIS ACIDIC DICATIONIC PHOSPHONIUM SALT

(71) Applicants: Dow Global Technologies LLC, Midland, MI (US); Dow Silicones Corporation, Midland, MI (US)

(72) Inventors: Ryan Maar, Midland, MI (US); Marc-Andre Courtemanche, Midland, MI (US); Anne-Catherine Bedard, Midland, MI (US)

(21) Appl. No.: 18/856,724

(22) PCT Filed: May 16, 2023
(86) PCT No.: PCT/US23/67032

§ 371 Date: Oct. 14, 2024

Related U.S. Application Data
(60) Provisional application No. 63/352,317, filed on Jun. 15, 2022.

(51) Int. Cl. C08G 77/08; B01J 27/18; C08G 77/00; C08G 77/04

(52) U.S. Cl. CPC C08G 77/08; B01J 27/1802; C08G 77/045; C08G 77/70

(57) ABSTRACT

A composition contains a phosphonium catalyst and a polyorganohydrogensiloxane. The composition is curable in a method including heating. The composition and method are useful for preparing polyorganosiloxane products such as coatings, adhesives, elastomers, and foams.

### CROSS REFERENCE TO RELATED APPLICATIONS

This application claims the benefit of U.S. Provisional Patent Application Ser. No. 63/352,317 filed on 15 Jun. 2022 under 35 U.S.C. § 119 (e). U.S. Provisional Patent Application Ser. No. 63/352,317 is hereby incorporated by reference.

### TECHNICAL FIELD

A curable polyorganohydrogensiloxane composition and methods for the preparation and cure thereof is provided. More particularly, the curable polyorganohydrogensiloxane composition includes a Lewis acidic dicationic phosphonium salt (catalyst) and a polyorganohydrogensiloxane.

### INTRODUCTION

Silyl hydride (Si—H) and siloxane linkages (Si—O—Si) have been found to undergo a rearrangement reaction in the presence of a strong Lewis acid where a silicon from the siloxane linkage becomes bound to the hydrogen of the silyl hydride while the silicon of the silyl hydride becomes bound to the oxygen of the siloxane linkage. The silyl hydride and siloxane linkage that participate in the rearrangement reaction can be on the same molecule or can be on different molecules. This rearrangement reaction tends to be rapid in the presence of a strong Lewis acid. Such a reaction can be useful for rapidly curing systems containing Si—H and siloxane linkages without requiring water or moisture. However, it requires a two-part system for storage where the Lewis acid catalyst is kept away from a combination of the silyl hydride and siloxane linkage until such time as curing is desired. It is desirable to be able to provide a shelf-stable one-component system that utilizes the rearrangement reaction that is shelf stable at room temperature, but that can be triggered with heating to cure.

### SUMMARY

A polyorganohydrogensiloxane composition (composition) comprises: a mixture of (A) a phosphonium catalyst comprising (i) a tetravalent dication of phosphorus and (ii) a non-coordinating anion; and (B) a polyorganohydrogensiloxane. Methods for preparing and curing the composition are provided.

### DETAILED DESCRIPTION

Starting material (A) used herein is a phosphonium catalyst, which comprises (i) a tetravalent dication of phosphorus and (ii) a non-coordinating anion. The tetravalent dication of phosphorus is a Lewis acidic phosphorus dication of formula (i-1): [P(R²)(R¹)]²⁺, where each R¹ is independently selected from the group consisting of a monovalent hydrocarbon group and a monovalent halogenated hydrocarbon group, and R² is a divalent or trivalent heteroaryl group. For R¹, the monovalent hydrocarbon group may be an alkyl group or an aryl group. For R¹, the monovalent halogenated hydrocarbon group may be an alkyl group or an aryl group (as introduced above and described in detail below) where one or more hydrogen atoms has been replaced with F, Cl, Br, or I.

Suitable alkyl groups for R¹ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Suitable halogenated alkyl groups include chloromethyl, trifluoromethyl, and trifluoropropyl.

Suitable aryl groups for R¹ may be monocyclic or polycyclic and may have pendant hydrocarbyl groups. For example, the aryl groups for R¹ include phenyl, tolyl, xylyl, and naphthyl and further include aralkyl groups such as benzyl, 1-phenylethyl and 2-phenylethyl. Alternatively, the aryl group for R¹ may be monocyclic, such as phenyl, tolyl, or benzyl; alternatively the aryl group for R¹ may be phenyl. Alternatively, R¹ may be a halogenated aryl group, such as chlorobenzyl. Alternatively, the halogenated aryl group for R¹ may have formula:

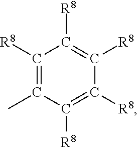

where each R⁸ is independently selected from H, X, and a group of formula —CX₃, where each X is an independently selected halogen; with the proviso that at least one R⁸ is not H. Each X may be independently selected from chlorine (Cl) or fluorine (F). Alternatively, each X may be F. Alternatively, each R⁸ may be independently selected from the group consisting of H, Cl, F, and a group of formula —CF₃, with the proviso that at least onc R⁸ is Cl, F, or —CF₃.

In formula (i-1), R², the divalent or trivalent heteroaryl group, may be selected from the group consisting of a bipyridine ligand and a terpyridine ligand. The bipyridine ligand may have formula:

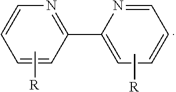

The terpyridine ligand may have formula:

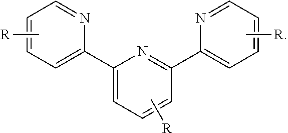

In the formulas for the bipyridine ligand and the terpyridine ligand, each R is independently selected from the group consisting of a hydrogen atom and a monovalent hydrocarbon group of 1 to 4 carbon atoms, e.g., an alkyl group selected from methyl, ethyl, propyl (including n-propyl and isopropyl), and butyl (including n-butyl, isobutyl, sec-butyl, and t-butyl). Alternatively, each R may be H. Alternatively, each R may be t-butyl.

Alternatively, (i) the tetravalent dication of phosphorus may have a formula selected from the group consisting of

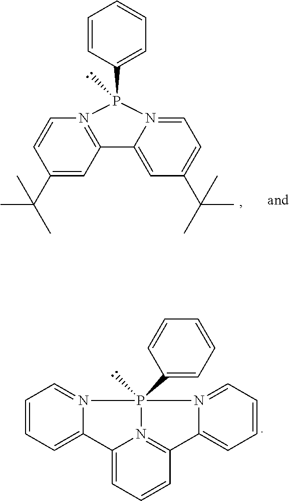

In (A) the phosphonium catalyst, (ii) the anion is a non-coordinating anion. The non-coordinating anion may have a charge that is delocalized over the surface of the anion, rather than localized at a specific atom. Suitable non-coordinating anions include trifluoromethane sulfonate (triflate) of formula [CF₃SO₃] and an anion of formula [BR³₄]⁻, where each R³ is independently selected from the group consisting of a monovalent hydrocarbon group (as described and exemplified above for R¹) and a monovalent halogenated hydrocarbon group (as described above and exemplified above for R¹).

Alternatively, the non-coordinating anion may be fully saturated and have no free valence electron to engage in a covalent or dative bond with the phosphonium. The fully saturated anion may have the formula [BR³₄], where each R³ is independently selected from the group consisting of a monovalent hydrocarbon group and a monovalent halogenated hydrocarbon group, as described above. Alternatively, each R³ may be a halogenated aryl group, as described above. Alternatively, (ii) the anion have formula: [B(C₆F₅)₄].

Alternatively, (A) the phosphonium catalyst may have formula [P(R¹)(R²)]²⁺[BR³₄]₂⁻, where R¹, R², and R³ are as described above. Alternatively, (A) the catalyst may have a formula selected from:

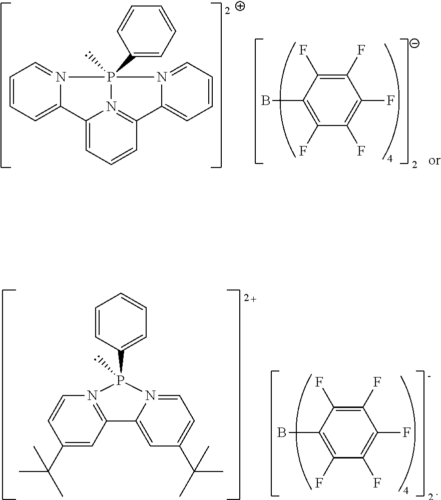

Starting material (A), the phosphonium catalyst, may be prepared by methods known in the art, such as that disclosed in Catalytic Hydrodefluorination of C-F Bonds by an Air-Stable P^{III} Lewis Acid by Chitnis, et al., Chem. Eur. J. 2018, 24, 6543-6546 by varying appropriate starting materials. Starting material (A) may be any one of the catalysts described above, or a combination of two or more of the catalysts described above.

The composition described herein contains a sufficient amount of (A) the phosphonium catalyst to cure the composition. The exact amount of (A) the phosphonium catalyst depends on various factors including the selection of (B) the polyorganohydrogensiloxane, the SiH content, and whether (C) the (non-functional) polyorganosiloxane is present. However, the composition may contain enough catalyst to provide a concentration of tetravalent dication of phosphorus that is 100 weight part per million weight parts (ppm) or more, one ppm or more, 1,000 ppm or more, 5,000 ppm or more, 10,000 ppm or more, 20,000 ppm or more 30,000 ppm or more, 40,000 ppm or more, 50,000 ppm or more; while at the same time 100,000 ppm or less, 90,000 ppm or less, 80,000 ppm or less, 70,000 ppm or less, or 60,000 ppm or less; based on weight of (B) the polyorganohydrogensiloxane, and when present, (C) the (non-functional) polyorganosiloxane in the composition. Alternatively, the amount of catalyst may be 100 ppm to 100,000 ppm; alternatively 10,000 ppm to 90,000 ppm; alternatively 20,000 ppm to 80,000 ppm; alternatively 30,000 ppm to 70,000 ppm; alternatively 50,000 ppm to 60,000 ppm.

### Starting Material (B) Polyorganohydrogensiloxane

The composition described herein further comprises (B) a polyorganohydrogensiloxane. The polyorganohydrogensiloxane may comprise both Si—H and Si—O—Si moieties. Therefore, the composition comprising (A) the phosphonium catalyst and (B) the polyorganohydrogensiloxane may cure to form a gel when heated, without additional components. Without wishing to be bound by theory, it is thought that (A) the phosphonium catalyst catalyzes rearrangement reaction of Si—H and Si—O—Si moieties both within the (B) polyorganohydrogensiloxane to cure the composition.

The polyorganohydrogensiloxane has at least one Si—H moiety per molecule. Alternatively, the polyorganohydrogensiloxane may have more than one Si—H moiety per molecule, such as 2 Si—H moieties per molecule or 3 Si—H moieties per molecule, or even more.

The polyorganohydrogensiloxane may comprise two or more siloxane units selected from the group consisting of HR⁴₂SiO_{1/2}, R⁴₃SiO_{1/2}, HR⁴SiO_{2/2}, R⁴₂SiO_{2/2}, R⁴SiO_{3/2}, HSiO_{3/2} and SiO_{4/2} units; wherein each R⁴ is an independently selected monovalent hydrocarbon group, which is free of aliphatic unsaturation; with the proviso that at least one unit, per molecule, contains an Si—H moiety (i.e., at least one of HR⁴₂SiO_{1/2}, HR⁴SiO_{2/2}, and HSiO_{3/2} is present in the polyorganohydrogensiloxanc). The monovalent hydrocarbon group, which is frcc of aliphatic unsaturation, may be an alkyl group or an aryl group, as described above for R³. Alternatively, each R⁴ may be an independently selected alkyl group. Alternatively, each R⁴ may be independently selected from the group consisting of methyl and phenyl. Alternatively, each R⁴ may be methyl.

Alternatively, (B) the polyorganohydrogensiloxane may be linear or cyclic. For example, (B) the polyorganohydrogensiloxane may be a linear polydiorganohydrogensiloxane comprising unit formula (B-1): (HR⁴₂SiO_{1/2}) g (R⁴₃SiO_{1/2})+ (R⁴₂SiO_{2/2}); (HR⁴SiO_{2/2}) j, where R⁴ is as described above, and subscripts g, h, i, and j have values such that g≥0, h≥0, a quantity (g+h)=2, i≥0, j≥0, and a quantity (g+j)≥1, and a quantity (i+j) is 0 to 2,000. The quantity (i+j) may be 2,000 or less, alternatively 1,000 or less, alternatively 750 or less, alternatively 500 or less, alternatively 250 or less, alternatively 100 or less, and alternatively 50 or less; while at the same time, the quantity (i+j) may be 0 or more, alternatively 1 or more, alternatively 2 or more, alternatively 3 or more, alternatively 4 or more, alternatively 5 or more, alternatively 10 or more, alternatively 15 or more, and alternatively 20 or more. Alternatively (i+j) may be 0 to 1,000; alternatively 1 to 500; alternatively 2 to 250, and alternatively 3 to 100. Alternatively (i+j) may be 1 to 100. Alternatively, (i+j) may be 2 to 50. Alternatively, (i+j) may be 5 to 25. Alternatively, when g=0 and h=2, j>1 (alternatively≥2). Alternatively, g may be 1, and h may be 1. Alternatively, g may be 2 and h may be 0. Alternatively, i may be 0 to 5, alternatively 1 to 4, alternatively 2 to 4, and alternatively 3 to 3.5. Alternatively, i may be 5 to 25. Alternatively, j may be 1 to 10, alternatively 2 to 9, alternatively 3 to 8, alternatively 4 to 7, and alternatively 5 to 6. Alternatively, when g>0, then j may be 0.

Suitable linear polydiorganohydrogensiloxanes for use herein are exemplified by:
(i) α,ω-dimethylhydrogensiloxy-terminated poly(dimethylsiloxane/methylhydrogensiloxane),
(ii) α,ω-dimethylhydrogensiloxy-terminated polymethylhydrogensiloxane,
(iii) α,ω-trimethylsiloxy-terminated poly(dimethylsiloxane/methylhydrogensiloxane),
(iv) α,ω-trimethylsiloxy-terminated polymethylhydrogensiloxane, and
(v) α-dimethylhydrogensiloxy-@-trimethylsiloxy-terminated poly(dimethylsiloxane/methylhydrogensiloxane),
(vi) α-dimethylhydrogensiloxy-@-trimethylsiloxy-terminated polymethylhydrogensiloxane,
(vii) a combination of two or more thereof.

Alternatively, the polyorganohydrogensiloxanc may be cyclic. For example, (B) the polyorganohydrogensiloxane may be ay cyclic polydiorganohydrogensiloxane, which may comprise unit formula (B-2): (R⁴₂SiO_{2/2})ᵤ(R⁴HSiO_{2/2}) v, where R⁴ is as described above, subscript u is 0 or more, subscript v is 1 or more, a quantity (u+v) is 3 to 15. Alternatively u may be 0. Alternatively, u may be 0 or more, alternatively 1 or more, alternatively 2 or more, alternatively 3 or more; while at the same time u may be up to 6, alternatively up to 5, and alternatively up to 4. Alternatively, u may be 0 to 6, alternatively 0 to 4, alternatively 0 to 2, and alternatively 1 to 6. Alternatively, v may be 1 or more, alternatively 2 or more, alternatively 3 or more, and alternatively 4 or more; while at the same time, v may be 12 or less, alternatively 10 or less, alternatively 8 or less, alternatively 6 or less, and alternatively 5 or less. Alternatively, v may have an average value of 4. Alternatively, v may be 1 to 12, alternatively 2 to 10, alternatively 3 to 8, alternatively 3 to 6, and alternatively 3 to 5. In unit formula (B-2), each R⁴ may be methyl. Examples of cyclic polyorganohydrogensiloxanes include (i) trimethylcyclotrisiloxane, (ii) tetramethylcyclotetrasiloxane, (iii) pentamethylcyclopentasiloxane, (iv) hexamethylcyclohexasiloxane, and (v) combinations of two or more thereof.

Suitable polyorganohydrogensiloxanes are known in the art and are commercially available. For example, DOWSIL™ 6-3570 Polymer, DOWSIL™ SH 1107 Fluids and XIAMETER™ MHX-1107 Fluids are available from The Dow Chemical Company of Midland, Michigan, USA. Polydiorganohydrogensiloxanes such as HMS-992 (trimethylsilyl terminated polymethyhydrosiloxane), HMS-HM271 (hydride-terminated methylhydrosiloxane-dimethylsiloxane copolymer), and HMS-031 (trimethylsiloxy-terminated methyhydrosiloxane dimethylsiloxane copolymer) are available from Gelest, Inc. of Morrisville, Pennsylvania, USA. Other polydiorganohydrogensiloxanes available from Gelest include HMS-H271, HMS-071, HMS-993; HMS-301 and HMS-301 R, HMS-991, HMS-993, HMS-082, HMS-151, HMS-013, HMS-053, HAM-301 (which is octyl functional), and HPM-502 (which is phenyl functional). Methods of preparing linear and branched polyorganohydrogensiloxanes suitable for use herein, such as hydrolysis and condensation of organohalosilanes, are well known in the art, as exemplified in U.S. Pat. No. 3,957,713 to Jeram et al.; U.S. Pat. No. 4,329,273 to Hardman, et al.; U.S. Pat. No. 4,370,358 to Hayes, et al.; U.S. Pat. No. 4,707,531 to Shirahata; U.S. Pat. No. 5,310,843 to Morita; and U.S. Pat. No. 2,823,218 to Speier, et al., which discloses organohydrogensiloxane oligomers and linear polymers as well as cyclic polymethyhydrogensiloxancs.

The amount of (B) the polyorganohydrogensiloxane in the composition depends on various factors including the Si—H content of the polyorganosiloxane, and whether (C) the polyorganosiloxane that is free of Si—H moieties is present. However, the amount of polyorganohydrogensiloxane may be 1 wt % or more, alternatively 5 wt % or more, alternatively 10 wt % or more, alternatively 20 wt % or more, alternatively 30 wt % or more, alternatively 40 wt % or more, alternatively 50 wt % or more, alternatively 60 wt % or more, alternatively 70 wt % or more, alternatively 80 wt % or more, alternatively 90 wt % or more, alternatively 95 wt % or more, and alternatively 99 wt % or more, while at the same time the amount of polyorganohydrogensiloxane may be <100 wt %, alternatively 99.9 wt % or less, alternatively 99.5 wt % or less, alternatively 99.1 wt % or less, alternatively 95 wt % or less, alternatively 90 wt % or less, alternatively 85 wt % or less, alternatively 80 wt % or less; each based on combined weight of starting materials (A), (B), and (C) in the composition. Alternatively, the amount of polyorganohydrogensiloxane may be 1 wt % to <100 wt %, alternatively 5 wt % to <100 wt %, alternatively 10 wt % to 99.9 wt %, on the same basis.

Alternatively, in addition to (B) the polyorganohydrogensiloxane, the composition may further comprise (C) a polyorganosiloxane that is free of Si—H moieties that may serve as a source of Si—O—Si moieties in the curing reaction for the composition.

### Starting Material (C) Polyorganosiloxane

Starting material (C) is an optional polyorganosiloxane that is free of Si—H moieties. The polyorganosiloxane comprises two or more siloxane units selected from R⁴₃SiO_{1/2}, R⁴₂SiO_{2/2}, R⁴SiO_{3/2}, and SiO_{4/2} units; wherein each R⁴ is an independently selected monovalent hydrocarbon group, which is free of aliphatic unsaturation. The monovalent hydrocarbon group, which is free of aliphatic unsaturation, may be an alkyl group or an aryl group.

Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl(and branched isomers having 5 to 18 carbon atoms), and the alkyl groups are further exemplified by cycloalkyl groups such as cyclopropyl, cyclobutyl, cyclopentyl, and cyclohexyl. Suitable halogenated alkyl groups include chlorinated alkyl groups such as chloromethyl and chloropropyl groups; fluorinated alkyl groups such as fluoromethyl, difluoromethyl, trifluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl.

Suitable aryl groups for R⁴ may be monocyclic or polycyclic and may have pendant hydrocarbyl groups. For example, the aryl groups for R³ include phenyl, tolyl, xylyl, and naphthyl and further include aralkyl groups such as benzyl, 1-phenylethyl and 2-phenylethyl. Alternatively, the aryl group for R⁴ may be monocyclic, such as phenyl, tolyl, or benzyl; alternatively the aryl group for R⁴ may be phenyl. The halogenated aryl group for R⁴ may have formula:

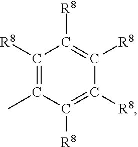

where each R⁸ is independently selected from H, X, and a group of formula —CX₃, where each X is an independently selected halogen; with the proviso that at least one R⁸ is not H. Each X may be independently selected from Cl or F. Alternatively, each X may be F. Alternatively, each R⁸ may be independently selected from the group consisting of H, Cl, F, and a group of formula —CF₃, with the proviso that at least one R⁸ is Cl, F, or —CF₃. Alternatively, each R⁴ may be an independently selected alkyl group. Alternatively, each R⁴ may be independently selected from the group consisting of methyl and phenyl. Alternatively, each R⁴ may be methyl.

Starting material (C) the polyorganosiloxane may be a polydiorganosiloxane, which may be linear or cyclic. For example, starting material (C) may be a linear polydiorganosiloxane comprising unit formula (C-1): (R⁴₃SiO_{1/2})₂(R⁴₂SiO_{2/2}) x, where R⁴ is as described above, and 1,000≥x≥1. Alternatively, subscript x may be at least 1, alternatively at least 2, alternatively at least 3, alternatively at least 5, alternatively at least 10, alternatively at least 25; while at the same time subscript x may be up to 1,000, alternatively up to 500, alternatively up to 250, alternatively up to 100, and alternatively up to 50. Alternatively, subscript x may have a value such that 500 24x≥1, alternatively 250≥x≥2, alternatively 100≥x≥5, alternatively 50≥x≥10, and alternatively 50≥x≥25.

Suitable linear polydiorganosiloxanes for use herein are exemplified by:
(i) α,ω-trimethylsiloxy-terminated polydimethylsiloxane,
(ii) α,ω-dimethylphenylsiloxy-terminated poly(dimethylsiloxane/methylphenylsiloxane),
(iii) α,ω-dimethylphenylsiloxy-terminated polymethylphenylsiloxane,
(iv) α,ω-trimethylsiloxy-terminated poly(dimethylsiloxane/methylphenylsiloxane),
(v) α,ω-trimethylsiloxy-terminated polymethylphenylsiloxane, and
(vi) a combination of two or more thereof.

Polydiorganosiloxanes are known in the art and are commercially available. For example, DOWSIL™ 200 Fluids, DOWSIL™ OS Fluids, and XIAMETER™ PMX-200 Silicone Fluids are commercially available from The Dow Chemical Company of Midland, Michigan, USA.

Alternatively, (C) the polyorganosiloxane may be a cyclic polydiorganosiloxane comprising unit formula (C-2): (R⁴₂SiO_{2/2}) y, where R⁴ is as described above, and 15≥y≥3. Alternatively, subscript y may be at least 3, alternatively at least 4, alternatively at least 5, and alternatively at least 6; while at the same time, subscript y may be up to 15, alternatively up to 12, alternatively up to 10, alternatively up to 8, and alternatively up to 6. Alternatively, subscript y may have a value such that 12≥ y≥3, alternatively 10≥ y≥3, alternatively 8≥ y≥3, alternatively 6≥ y≥3, and alternatively 6≥ y≥4.

Examples of cyclic polydiorganosiloxanes include hexamethylcyclotrisiloxane, octamethylcyclotetrasiloxane, decamethylcyclopentasiloxane, dodecamethylcyclohexasiloxane, and a combination of two or more thereof. These cyclic polydiorganosiloxanes are commercially available, e.g., from Sigma-Aldrich, Inc. of St. Louis, Missouri, USA.

Starting material (C) is optional. However, when present, the amount of starting material (C) depends on various factors including the type of polyorganohydrogensiloxane selected for starting material (B) and its Si—H content. The amount of (C) the polyorganosiloxane may be 0 to <99 weight % based on combined weight of starting materials (A), (B), and (C) in the composition.

### Starting Material (D) Solvent

Starting material (D) is an optional solvent, which may be used to facilitate combination of starting materials (A) and (B), and, when present (C), in the composition and method described herein. Solvents used herein are those that help fluidize the starting materials, but essentially do not react with any of these starting materials. Solvent may be selected based on solubility of the starting materials and volatility of the solvent. The solubility refers to the solvent being sufficient to dissolve and/or disperse the starting materials. Volatility refers to vapor pressure of the solvent. For example, starting material (A), the phosphonium catalyst, may be dissolved in a solvent before combining starting material (A) with starting material (B) (and when present (C)). Alternatively, starting material (B) may be dissolved in a solvent before combining with starting material (A) (and (C), when present) when starting material (B) is a viscous fluid, such as a gum, or a solid at RT, such as a resin. Alternatively, starting material (C) may be dissolved in a solvent before combining with starting materials (A) and (B), e.g., when starting material (C) is a solid at RT, such as a resin or a gum. The solvent may be used in any amount, which will be selected by one of skill in the art, depending on various factors, such as the selection of starting materials (A) and (B) (and when present (C)) and their solubilities.

Suitable solvents may be hydrocarbons. Suitable hydrocarbons include aromatic hydrocarbons such as benzene, toluene, or xylene; and/or aliphatic hydrocarbons such as heptane, hexane, or octane. Alternatively, the solvent may be a halogenated hydrocarbon such as chloroform, 1,1,1-trichloroethane or methylene chloride. One solvent, or a combination comprising two or more solvents, may be used herein.

The amount of solvent can depend on various factors including the type of solvent selected and the amounts and types of other starting materials selected. However, the amount of solvent may be 0.1 wt % or more, alternatively 2 wt % or more, while at the same time the amount of solvent may be up to 99 wt %, alternatively up to 50 wt %, based on combined weights of starting materials (A), (B), and (C). Alternatively, the amount of (D) the solvent may be 0.1 wt % to 99 wt %, alternatively 2 wt % to 50 wt %, based on combined weights of (A) the catalyst, (B) the polyorganohydrogensiloxane, and (C) the polyorganosiloxane compound in the composition.

The composition can consist of (A) the phosphonium catalyst and (B) the polyorganohydrogensiloxane (and when present, (C) the polyorganosiloxane and/or (D) the solvent). Alternatively, the composition described herein may optionally further comprise an additional component. An optional additional component may be present at a concentration of 50 wt % or less, 40 wt % or less, 30 wt % or less, 20 wt % or less, 10 wt % or less, 5 wt % or less, or even one wt % or less based on composition weight. Alternatively, an optional additional component may be present at a concentration of 0 to 50 wt %, alternatively 0 to 40 wt %, alternatively 0 to 30 wt %, alternatively 0 to 20 wt %, alternatively 0 to 10 wt %, alternatively 0 to 5 wt %, and alternatively 1 wt % to 30 wt %.

### Optional Additional Components

Examples of possible optional components include one or a combination of more than one component selected from a group consisting of pigments such as carbon black or titanium dioxide, fillers such as metal oxides including SiO₂ (e.g., at a concentration of 50 wt % or less based on composition weight), moisture scavengers, fluorescent brighteners, stabilizers (such as antioxidants and ultraviolet stabilizers), and corrosion inhibitors. The composition alternatively can be free of any one or any combination of more than one such additional components. In addition, the composition can contain one wt % or less, alternatively 0.5 wt % or less water relative to composition weight. Alternatively, the composition may be free of water.

The composition described herein may be free of transition metals. “Free of transition metals” means that the composition contains none, or a non-detectable amount, or an amount insufficient to gel the composition at room temperature after 24 hours, of a metal in Groups 4-12 of the IUPAC Periodic Table of the Elements dated 1 Dec. 2018. Without wishing to be bound by theory, it is thought that transition metals may catalyze reaction of Si—H and Si—O moieties, at an undesirably low temperature (e.g., <65° C.).

The composition described herein may be free of Lewis base. “Free of Lewis base” means that the composition contains none or an insufficient amount of a compound or ionic species, that can donate an electron pair to (A) the phosphonium catalyst, to prevent the composition from sufficiently curing to form a gel within 20 minutes when heated at 65° C. For example, the composition may be free of a Lewis base selected from a group consisting of the following bases: PR¹⁰₃, P(NR¹⁰₂)₃, NR¹⁰₃, N(SiR¹⁰₃),R¹⁰₃₋ₓ, R¹⁰C(NR¹⁰)N, P(N—R¹⁰)R¹⁰₃, guanidines (C(═NR¹⁰)(NR¹⁰₂)₂), amidines (R¹⁰C(═NR¹⁰) NR¹⁰₂), phosphazenes, and;

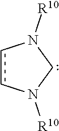

where R¹⁰ is in each occurrence independently selected from a group consisting of hydrogen, alkyl, substituted alkyl, aryl and substituted aryl.

### Method

The composition described above may be a one part composition. The one part composition contains starting materials (A) and (B) in the same part. The composition may be prepared in a method, which comprises step: i) combining starting materials comprising (A) the phosphonium catalyst, (B) the polyorganohydrogensiloxane, and when present (C) the polyorganosiloxane, (D) the solvent, and/or the optional additional component, described above, thereby forming a mixture. Starting material (D) the solvent may be used to facilitate combining starting materials (A) and (B), and when present (C). For example, one or more of starting materials (A) and (B), and when present (C), may be dissolved in the solvent before being mixed with the other starting materials. Alternatively, the starting materials in may consist essentially of starting materials (A) and (B) (and optionally (C) and/or (D)), described above. Alternatively, the starting materials may consist of starting materials (A) and (B) (and optionally (C) and/or (D)), described above.

Combining the starting materials to form the mixture and prepare the polyorganohydrogensiloxane composition is performed under conditions that will not cure (e.g., not significantly react the Si—H moieties from (B) the polyorganohydrogensiloxane and the Si—O—Si moieties (from (B) the polyorganohydrogensiloxane and/or (C) the polyorganosiloxane). These conditions may comprise mixing, e.g., by any convenient means. Mixing may be performed using conventional mixing equipment, such as an agitated batch kettle. Alternatively, when the polyorganosiloxane selected for starting material (C) and/or the polyorganohydrogensiloxane selected for starting material (B) is viscous or solid (e.g., gum or resin), mixing under shear may be performed, e.g., with an extruder. The composition may be formed, e.g., by mixing starting materials comprising (A) and (B) described above. Starting materials (A) and (B) may be combined at RT or less. Alternatively, the temperature for combining starting materials (A) and (B) (and (C) and/or (D), when present) may be 5° C. to 30° C. Starting materials (A) and (B), (and (C) and/or (D), when present) may be combined concurrently. Alternatively, starting materials (A) and (B) (and (D), when present) may be combined to form a mixture, and thereafter the mixture may be combined with starting material (C) (and additional (D), when present), e.g., by adding starting material (C) (or a solvent solution thereof) to said mixture, e.g., by metering over a period of time or by adding in one or more aliquots.

### Curing the Composition

A method for curing the composition comprises:
1) providing the composition, as described above, and
2) heating the composition to a temperature sufficient to catalyze reaction of silicon bonded hydrogen atoms in (B) the polyorganohydrogensiloxane. For example, the temperature in step 2) may be ≥65° C. Alternatively, the temperature may be >30° C., but the time for reaction may be longer at lower temperatures than at higher temperatures. The method for curing the composition may optionally further comprise an additional step. For example, the method may further comprise an additional step after step 1) and before step 2), wherein the additional step comprises placing the composition in a mold or applying the composition on a substrate.

### EXAMPLES

These examples are provided to illustrate the invention to one skilled in the art and are not to be construed as limiting the scope of the invention set forth in the claims. Starting materials used in these examples are shown in Table 1.

TABLE 1
Starting Materials

| Ingredient | | Chemical Description, Chemical | |
|---|---|---|---|
| Type | Product Name | formula, or Structure | Source |
| Reagent 1 | D^{H}ₓ | Cyclic polymethylhydrogensiloxane | The Dow |
| | | with density 0.98 g/mL, and formula | Chemical |
| | | 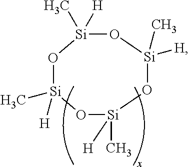 | Company |
| | | where subscript x is 1 to 3 | |
| Catalyst 1 | [terpyPPh][B(C₆F₅)₄]₂ | See structure below. | Prepared at |
| | | | The Dow |
| | | | Chemical |
| | | | Company |
| | | | according to, |
| | | | Chem. Eur. J. |
| | | | 2018, 24, |
| | | | 6543-6546. |
| FAB | (C₆F₅)₃B | tris(pentafluorophenyl)borane | Sigma- |
| (comparative | | | Aldrich |
| catalyst) | | | |
| Solvent | Dichloromethane | CH₂Cl₂ | Sigma- |
| | | | Aldrich |

### Catalyst 1 Structure:

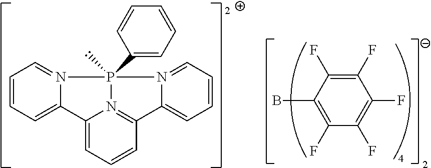

### Reference Example 1—General Conditions

The reactions were carried out in an N2-filled glovebox using solvents that were dricd over 4 Å molecular sieves. Except as specified in Table 1, all starting materials were obtained from commercial sources and used as received.

A stock solution of Catalyst 1 was prepared as follows: [terpyPPh][B(C₆F₅) 4](56 mg) was dissolved in CH₂Cl₂ (1 mL) to afford a 56 mg/mL solution.

A stock solution of FAB was prepared as follows: FAB (2.6 mg) was dissolved in CH₂Cl₂ (5.8 mL) to afford FAB stock solution A (0.44 mg/mL).

### Reference Example 2—Reaction Setup & Progress

D^{H}ₓ (1 mL, 0.98 g) was added to a 30 mL vial containing a magnetic stir bar. To this vial was added 1 mL of the Catalyst 1 stock solution (56 mg of [terpyPPh][B(C₆F₅) 4]). The resulting solution was either stirred at 65° C. via a pre-heated aluminum block. The reaction was monitored at different time intervals to see if a gel had formed. Gel formation was indicative of crosslinking (curing). No effort was made to remove the cured material from the vial. The results are shown below in Table 2.

### Reference Example 3—Comparative Example Reaction Setup & Progress

Reference Example 2 was repeated, except 0.2 mL of the FAB stock solution (0.088 mg of FAB) was used. The results are shown below in Table 2.

TABLE 2
Results for curing of D^{H}ₓ using FAB (comparative) and catalyst
1 (inventive). Catalysts were delivered in CH₂Cl₂.

| | | Stock | Amount | | CAT loading | |
|---|---|---|---|---|---|---|
| | Example | solution | of stock | D^{H}ₓ | vs. D^{H}ₓ | |
| CAT | Type | conc. | added | (mL) | (ppm) | Observation |
| FAB | Comparative | 0.44 mg/mL | 0.2 mL (0.088 | 1 | 90 | Gel at r.t. |
| | | (CH₂Cl₂) | mg of FAB) | | | after 20 min |
| 1 | Inventive | 56 mg/mL | 1 mL (56 | 1 | 57142 | Gel at 65° C. |
| | | (CH₂Cl₂) | mg of 2) | | | after 0.5 h |

### Industrial Applicability

The composition described above is shelf stable, which means that the composition does not gel at RT in 0.5 hour or less, alternatively 1 hour or less, alternatively 5 hours or less, alternatively 24 hours or less, alternatively 48 hours or less, and alternatively 36 hours or less. The composition and method described herein are useful for preparing and curing siliconc compositions that cure to form products such as coatings, adhesives, elastomers, and foams. The inventors surprisingly found that the catalyst described herein will cure the polyorganosiloxane composition. Furthermore, the inventors surprisingly found that there is no need for a Lewis base and/or a bridging molecule to stabilize the catalyst described herein. Without wishing to be bound by theory, it is thought that, the presence of a Lewis base such as triethylamine, can render the present composition incurable under the conditions tested in the examples above. The composition and method of this invention provide a polyorganohydrogensiloxane composition that is shelf stable at RT and that is curable with heating to mild temperatures.

### Definitions and Usage of Terms

Abbreviations used in the specification have the definitions in Table 3, below.

TABLE 3
Abbreviations

| Abbreviation | Definition |
|---|---|
| ASTM | ASTM International |
| ° C. | degrees Celsius |
| g | grams |
| GPC | gel permeation chromatography |
| h | hours |
| mg | milligrams |
| min | minutes |
| mL | milliliters |
| mmol | millimoles |
| Ph | phenyl |
| ppm | parts per million |
| RT or r.t. | room temperature of 23° C. ± 2° C. |
| s | seconds |
| wt | weight |

All amounts, ratios, and percentages are by weight unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated by the context of specification. The singular includes the plural unless otherwise indicated.

The term “comprising” and derivatives thereof, such as “comprise” and “comprises” are used herein in their broadest sense to mean and encompass the notions of “including,” “include,” “consist (ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

Generally, as used herein a hyphen “-” or dash “-” in a range of values is “to” or “through”; a “>” is “above” or “greater-than”; a “>” is “at least” or “greater-than or equal to”; a “<” is “below” or “less-than”; and a “<” is “at most” or “less-than or equal to.”

### Embodiments of the Invention

In a first embodiment, a composition comprises a mixture of:
100 ppm to 100,000 ppm by weight, based on combined weights of starting materials (A) and (B) of (A) a phosphonium catalyst comprising
   (i) a tetravalent dication of phosphorus of formula [P(R²)(R¹)]2+, where R¹ is an aryl group, and R² is a bipyridine ligand or a terpyridine ligand; and
   (ii) a non-coordinating anion of formula [BR³₄], where each R³ is an independently selected halogenated aryl group;
1 weight % to <100 weight % based on combined weights of starting materials (A), (B), and (C), of (B) a polydiorganohydrogensiloxane selected from the group consisting of
   a linear polydiorganohydrogensiloxane comprising unit formula (B-1): (HR⁴₂SiO_{1/2}) g (R⁴₃SiO_{1/2}) h (R⁴₂SiO_{2/2}) i (HR⁴SiO_{2/2}) j, where each R⁴ is an independently selected monovalent hydrocarbon group, which is free of aliphatic unsaturation, and subscripts g, h, i, and j have values such that g≥0, h>0, a quantity (g+h)=2, i≥0, j>0, and a quantity (g+j)≥1, and a quantity (i+j) is 0 to 2,000;
   a cyclic polydiorganohydrogensiloxane comprising unit formula (B-2): (R⁴₂SiO_{2/2}) u (R⁴HSiO_{2/2}) v, where R⁴ is as described above, subscript u is 0 or more, subscript v is 1 or more, a quantity (u+v) is 3 to 15; and
   (B-3) a combination of both (B-1) and (B-2).

In a second embodiment, in the composition of the first embodiment, (A) the phosphonium catalyst compriscs:

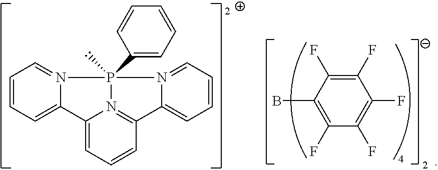

In a third embodiment, in the composition of the first embodiment or the second embodiment, (B) the polyorganohydrogensiloxane is selected from the group consisting of:
(i) α,ω-dimethylhydrogensiloxy-terminated poly(dimethylsiloxane/methylhydrogensiloxane),
(ii) α,ω-dimethylhydrogensiloxy-terminated polymethylhydrogensiloxane,
(iii) α,ω-trimethylsiloxy-terminated poly(dimethylsiloxane/methylhydrogensiloxane),
(iv) α,ω-trimethylsiloxy-terminated polymethylhydrogensiloxane, and
(v) α-dimethylhydrogensiloxy-@-trimethylsiloxy-terminated poly(dimethylsiloxane/methylhydrogensiloxane),
(vi) α-dimethylhydrogensiloxy-@-trimethylsiloxy-terminated polymethylhydrogensiloxane,
(vii) a combination of two or more thereof.

In a fourth embodiment, in the composition of the first embodiment or the second embodiment, (B) the polyorganohydrogensiloxane is selected from the group consisting of: hexamethylcyclotrisiloxane, octamethylcyclotetrasiloxane, decamethylcyclopentasiloxane, dodecamethylcyclohexasiloxane, and a combination of two or more thereof.

In a fifth embodiment, in the composition of any one of the first to fourth embodiments, (C) the polyorganosiloxane is selected from the group consisting of: «,@-trimethylsiloxy-terminated polydimethylsiloxane, α,ω-dimethylphenylsiloxy-terminated poly(dimethylsiloxane/methylphenylsiloxane), α,ω-dimethylphenylsiloxy-terminated polymethylphenylsiloxane, α,ω-trimethylsiloxy-terminated poly(dimethylsiloxane/methylphenylsiloxane), α,ω-trimethylsiloxy-terminated polymethylphenylsiloxane, hexamethylcyclotrisiloxane, octamethylcyclotetrasiloxane, decamethylcyclopentasiloxane, dodecamethylcyclohexasiloxane, and a combination of two or more thereof.

In a sixth embodiment, in the composition of any one of the first to fifth embodiments, the composition further comprises 1 weight % to 99 weight %, based on total weight of the composition, of (D) a solvent.

In a seventh embodiment, the composition of any one of the first to sixth embodiments is used for preparing a product selected from the group consisting of a coating, an adhesive, an elastomer, and a foam.

In an eighth embodiment, where the composition of any one of the first to sixth embodiments is a cure system, and a method comprises i) adding the composition to a polyorganosiloxane formulation and ii) curing the polyorganosiloxane formulation to form a product selected from the group consisting of a coating, an adhesive, an elastomer, and a foam.

1. A composition comprising a mixture of (A) a phosphonium catalyst comprising (i) a Lewis acidic phosphorus dication and (ii) a non-coordinating anion; and (B) a polyorganohydrogensiloxane.

2. The composition of claim 1, where (i) the Lewis acidic phosphorus dication has formula [P(R²)(R¹)]²⁺, where each R¹ is independently selected from the group consisting of a monovalent hydrocarbon group and a monovalent halogenated hydrocarbon group and R² is a divalent or trivalent heteroaryl group.

3. The composition of claim 2, where R² is selected from the group consisting of a terpyridine ligand of formula 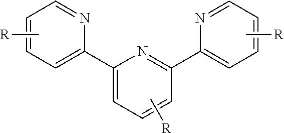
and a bipyridine ligand of formula 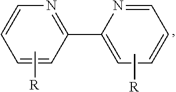
where each R is independently selected from the group consisting of a hydrogen atom, and an alkyl group of 1 to 6 carbon atoms.

4. The composition of claim 3, where each R is selected from the group consisting of H and tert-butyl.

5. The composition of claim 4, where R² is selected from the group consisting of

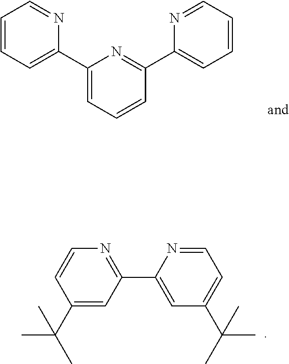 [SMILES: c1ccc(-c2cccc(-c3ccccn3)n2)nc1 ; CC(C)(C)c1ccnc(-c2cc(C(C)(C)C)ccn2)c1]

6. The composition of claim 1, where (ii) the non-coordinating anion has formula [BR³₄]⁻ where each R³ is independently selected from the group consisting of a monovalent hydrocarbon group or a monovalent halogenated hydrocarbon group.

7. The composition of claim 6, where (ii) the non-coordinating anion has formula [B(C₆F₅)₄]⁻.

8. The composition of claim 7, where (A) the phosphonium catalyst has formula

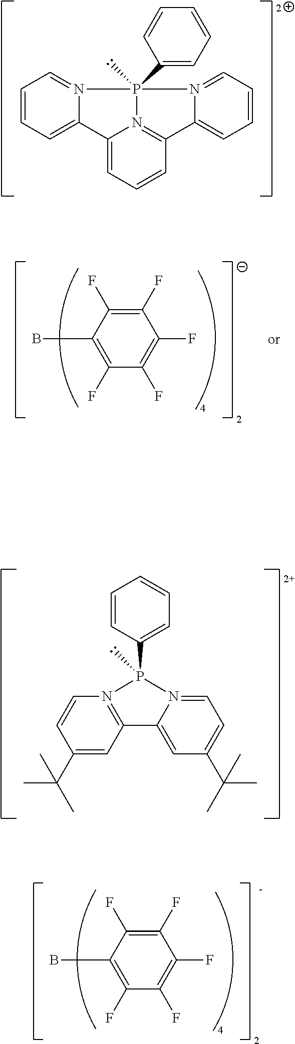

9. The composition of claim 1, where (B) the polyorganohydrogensiloxane comprises two or more siloxane units selected from the group consisting of HR⁴2SiO_{1/2}, R⁴₃SiO_{1/2}, HR⁴SiO_{2/2}, R⁴₂SiO_{2/2}, R⁴SiO_{3/2}, HSiO_{3/2} and SiO_{4/2} units; wherein each R⁴ is an independently selected monovalent hydrocarbon group, which is free of aliphatic unsaturation.

10. The composition of claim 9, where (B) the polyorganohydrogensiloxane is selected from the group consisting of:
(B-1) a linear polyorganohydrogensiloxane comprising unit formula (HR⁴₂SiO_{1/2}): (R⁴₃SiO_{1/2})ₕ(R⁴₂SiO_{2/2}); (HR⁴SiO_{2/2})ⱼ, where R⁴ is as described above, and subscripts g, h, i, and j have values such that g≥0, h≥0, a quantity (g+h)=2, i≥0, j≥0, and a quantity (g+j)≥1, and a quantity (i+j) is 0 to 1,000;
(B-2) a cyclic polyorganohydrogensiloxane comprising unit formula (R⁴₂SiO_{2/2}) u (R⁴HSiO₂₂₂) v, where subscript u is 0 or more, subscript v is 1 or more, a quantity (u+v) is 3 to 15, and each R is an independently selected monovalent hydrocarbon group; and
(B-3) a combination of both (B-1) and (B-2).

11. The composition of claim 1, further comprising (C) a polyorganosiloxane, wherein (C) the polyorganosiloxane comprises two or more siloxane units selected from R⁴₃SiO_{1/2}, R⁴₂SiO_{2/2}, R⁴SiO_{3/2}, and SiO_{4/2} units; wherein each R⁴ is an independently selected monovalent hydrocarbon group, which is free of aliphatic unsaturation.

12. The composition of claim 11, where (C) the polyorganosiloxane is selected from the group consisting of
(C-1) a linear polydiorganosiloxane comprising unit formula:
(R⁴₃SiO_{1/2}) 2 (R⁴₂SiO_{2/2}) x, where R⁴ is as described above, and 1,000≥x≥1;
(C-2) a cyclic polydiorganosiloxane comprising unit formula: (R⁴₂SiO_{2/2}) y, where R⁴ is as described above, and 15≥y≥3; and
(C-3) a combination of both (C-1) and (C-2).

13. The composition of claim 1, further comprising (D) a solvent.

14. The composition of claim 1, where the composition is free of transition metals.

15. A method comprising the steps of:
1) providing a composition according to claim 1, and
2) heating the composition to a temperature sufficient to catalyze reaction of silicon bonded hydrogen atoms in (B) the polyorganohydrogensiloxane, and optionally the method further comprises an additional step after step 1) and before step 2), wherein the additional step further comprises placing the composition in a mold or applying the composition on a substrate.
